(19) United States
(12) Patent Application Publication
(10) Pub. No.: US 2007/0195702 A1
(43) Pub. Date: Aug. 23, 2007

(54) Link duration based routing protocol for multihop ad hoc networks

(76) Inventors: Wing Ho Yuen, Fort Lee, NJ (US); Shiwen Chen, Marlboro, NJ (US); King Huang, East Brunswick, NJ (US); Harumine Yoshiba, Kanagawa-ken (JP)

Correspondence Address: GREGORY A. STOBBS, 5445 CORPORATE DRIVE, SUITE 400, TROY, MI, 48098, US

(21) Appl. No.: 11/357,867

(22) Filed: Feb. 17, 2006

(51) Int. Cl. H04J 3/14

(52) U.S. Cl. 370/238

(57) ABSTRACT

A method is provided for selecting a route for transmitting data packets amongst nodes in an ad hoc network. The method includes determining a metric which is indicative of link stability between the nodes in the network; initiating a route discovery procedure that generates a plurality of candidate transmission paths between a source node and a destination node; and selecting a transmission path from amongst the plurality of candidate paths using the metric for nodes associated with each candidate path. The metric may be further defined as link duration (i.e., an amount of time the node maintains a link with neighboring nodes link duration).

### FIELD

The present disclosure relates to routing protocols for mobile ad hoc networks and, more particularly, to routing protocols which employs link duration as a route metric.

### BACKGROUND

In mobile ad hoc networks, nodes communicate to each other without the use of infrastructure such as access points or base stations. Nodes may act as the source, destination and router of packets. Since nodes are spatially distributed over a large area, any two nodes may not be able to communicate directly due to the finite radio transmit range. When a source node has packets to transmit, typically it will invoke route discovery mechanisms to find a multi-hop route to the destination. Routes are created on demand and route maintenance is performed to update routes as network topology changes. These routing mechanisms fall under the category of on-demand routing schemes.

Most ad hoc routing protocols differ in the mechanisms in which routes are discovered. Shortest path routing is often used to minimize the number of hops to deliver a packet from the source node to destination. In work from DeCouto et. al., measurements from an experimental test bed revealed that min-hop routing often leads to selection of suboptimal routes. Multi-path fading plays an important role. As a result of fading, traditional neighbor abstraction of wired networks that links are either directly connected or not at all ceases to hold. Instead, most links have intermediate packet delivery probabilities. The shortest path from a source node to the destination node usually involves links that span long distance, which are more susceptible to fading and have higher packet loss rates. This in turn leads to frequent packet retransmissions on the shortest path, degrading throughput performance significantly.

Instead minimizing the number of hops, routes may also be selected to minimize the expected number of transmissions (ETX) for end-to-end packet delivery. Each link is labeled by an edge weight that represents the expected number of transmissions to deliver a packet successfully over that link. The determination of this link metric involves empirical measurement of packet loss rate on both sides of the link. Each node periodically broadcasts probe or hello packets to its neighbors. By monitoring the number of received hello packets from a neighbor node over a moving time window, an estimate of the current link loss rate is obtained. The expected number of transmissions for a packet to be successfully delivered over a link is a simple function of packet loss rates on both forward and reverse directions. Experimental results demonstrate that ETX metric significantly outperforms the hop count routing metric.

To extend node bandwidth, each node may be equipped with multiple 802.11 radios that transmits at different rates and may tune to different carrier frequencies. In multi-rate scenarios, it is appropriate to minimize expected transmission time (ETT) rather than expected number of transmissions (ETX). This exploits links with data rates and minimizes the interference to other flows. The ETT link metric is a function of forward and reverse packet loss rate, as well as the available bandwidth. Again, these parameters are empirically measured using periodic hello packets.

The efficacy of both ETX and ETT metrics depends on the accuracy of packet loss rate measurements. Prior measurement studies have revealed that packet loss rate of a link does not change appreciatively with time in static scenarios. As such, packet loss rate derived from earlier measurements still accurately depicts current link quality. Indeed, both ETX and ETT metrics yields significant throughput improvement over the hop count routing metric. However, in mobile scenarios packet loss rate may not be a good link quality metric to use. If a mobile node moves sufficiently quick, earlier packet loss rate measurements would be incorrect at the time of route discovery. For example, a mobile experiment is performed in which the sender node roams around a network of static nodes. A permanent TCP connection is set up between the mobile sender and a fixed destination in the static network. Experimental result shows that ETX metric is inferior to the min-hop metric. As node mobility shuffles node locations, the ETX metric does not react quickly enough to track changes in link quality. Indeed, node mobility introduces frequent changes to packet loss probabilities of links. Packet loss profiles collected through measurements are likely outdated. Thus, in mobile scenarios, selection of routes based on measurement of time varying packet loss profiles such as ETX and ETT metrics is inefficient.

Therefore, it is desirable to provide a metric for selecting routes in a mobile ad hoc network environment. The statements in this section merely provide background information related to the present disclosure and may not constitute prior art.

### SUMMARY

A method is provided for selecting a route for transmitting data packets amongst nodes in an ad hoc network. The method includes determining a metric which is indicative of link stability between nodes in the network; initiating a route discovery procedure that generates a plurality of candidate transmission paths between a source node and a destination node; and selecting a transmission path from amongst the plurality of candidate paths using the metric for nodes associated with each candidate path. In one aspect of this disclosure, the metric is further defined as link duration.

Further areas of applicability will become apparent from the description provided herein. It should be understood that the description and specific examples are intended for purposes of illustration only and are not intended to limit the scope of the present disclosure.

### DRAWINGS

FIGS. 1A-1C illustrate the route discovery procedure for a typical reactive routing protocol;

FIG. 2 is a flowchart depicting an exemplary routing protocol which employs link duration as a routing metric;

FIG. 3 is a diagram illustrating a nodal link duration measurement;

FIG. 4 is a diagram illustrating a nodal link duration measurement in a mobile scenario;

FIG. 5 is a diagram illustrating a nodal link duration measurement with a sampling window;

FIG. 6 is a diagram illustrating the cycle duration of a reactive protocol;

FIGS. 7A and 7B depict two exemplary network configurations;

FIG. 8 illustrates how a link duration based routing protocol might be integrated into the software architecture of a network node; and

FIGS. 9 and 10 depict exemplary application scenarios in which link duration based routing protocol may be deployed.

### DETAILED DESCRIPTION

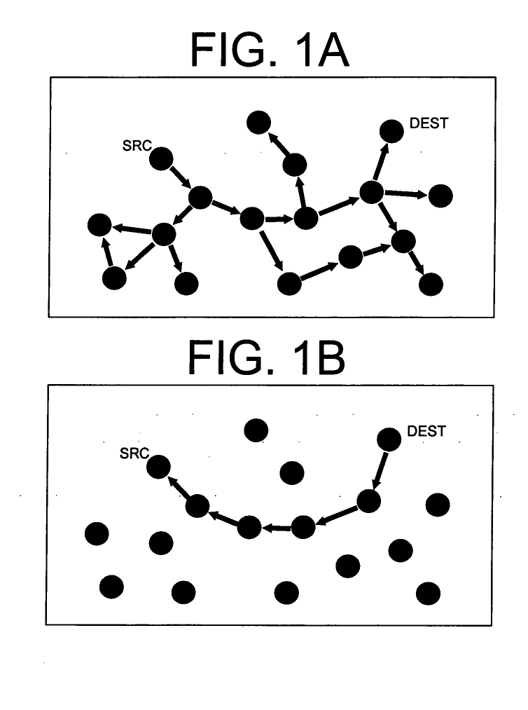

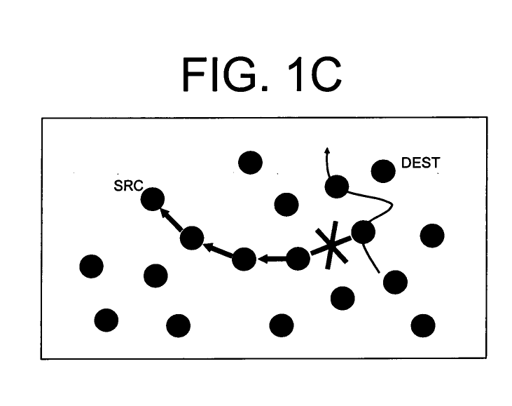

A brief discussion of on demand routing protocols provides a backdrop for the present disclosure. In on demand routing protocols, no routing table is kept permanently at each node. Instead, a route is created on demand when a source node requests it. This involves a route discovery procedure in which a route request packet is flooded into the network as illustrated in FIG. 1A. When a destination node receives the route request packet, it unicasts a route reply message back to the source node to complete the route setup procedure, as shown in FIG. 1B. Since nodes are mobile in an ad hoc network, a route maintenance procedure must also be specified to repair a route when a link failure occurs along the path. As shown in FIG. 1C, when a node detects a link failure, a route error message is unicasted back to the source node. The source node then initiates another round of route discovery to repair the broken route. Reactive routing is by far the most popular paradigm in ad hoc routing protocols. It relieves the burden of maintaining a routing table at individual nodes, which is prohibitive in cost in high mobility scenarios.

In the routing algorithm described above, a key differentiator may be the link metric used to evaluate a multi-hop route. There are several salient characteristics of a good link metric. First, the link metric must accurately describe link quality in both mobile and stationary scenarios. Second, the link metric should be slowly changing with time. In practice, link metric is obtained by measurement over a sampling interval. If the link metric is time varying, it is outdated by the time it is used in route selection. Third, computation of link metric should incur low overhead. Fourth, the performance metric or routing metric must be closely related with the link metric. If the performance metric is an explicit function of the link metrics along the path, in principle the optimal path can be determined by an exhaustive search of all routes. In min-hop routing, hop count is used as the link metric. Although end-to-end throughput depends on the hop count, hop count does not convey any information on link quality. Thus, hop count as a link metric fails the first criterion. On the other hand, both ETX and ETT metrics rely on timely measurement of packet loss rate. Since packet loss rate changes drastically in mobile scenarios, these two metrics fail the second criterion.

Therefore, this disclosure proposes the use of link duration to characterize link quality. It satisfies the four mentioned characteristics of an ideal link metric. First, link duration quantifies the susceptibility of a link to errors in both mobile and stationary scenarios. In mobile scenarios, link error is dominated by node mobility. Links of a high speed node to neighbors generally have shorter link durations and are prone to link failure. Thus paths that involve highly mobile nodes should be avoided in route selection. This prevents frequent invocation of route maintenance due to link failure. For most mobility models, link duration is highly correlated to node speed. A history of link duration thus conveys useful information about the usability of a node and the corresponding links. On the other hand, channel fluctuation due to multi-path fading is the main source of link errors in stationary network scenarios. In the absence of mobility, link duration is strongly dependent on the underlying link loss rate. Links with small link durations have high packet loss rate and therefore should be avoided in route selection. Since link duration is closely related to link errors in both mobile and stationary scenarios, the first criterion is satisfied.

Second, link duration changes slowly in both static and mobile scenarios. Typically, a link is declared down when several consecutive hello packets are lost. Since packet loss rate of individual hello packets is almost constant in static scenario, the probability distribution of link duration is also quasi-static. Link duration is also slowly varying with time in mobile scenario. Suppose a node moves with a constant speed. The constant speed assumption is plausible since the time scale of speed change is usually much larger than the time scale of a communication session. If link duration is monitored over an extended time interval, the average link duration converges to a fixed value. In contrast, change of communication distances due to node mobility shuffle packet loss rate completely. Thus link duration satisfies the second criterion.

Link duration measurements are also readily available using simple link layer hello messages. In fact, some routing protocols specify the use of hello packets on link layer to expedite detection of link failures. As such, measurement of link duration does not incur additional communication overhead. By counting the number of hello packets received from a neighbor until link failure, link duration is determined at the granularity of a hello period.

Finally, many performance metrics are explicit functions of link durations. For instance, the performance metrics of path duration and throughput are explicitly dependent on the link durations of nodes along the path. Thus, the fourth criterion is also satisfied. While the following description focuses on apply link duration in mobile scenarios, it is also suitable for use as a routing metric in stationary network environments.

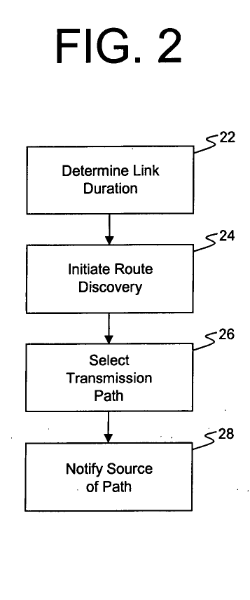

FIG. 2 provides an overview of an exemplary routing protocol which employs link duration as a routing metric. Prior to establishing path, each node obtains empirical information related to the stability of its link to other nodes. In an exemplary embodiment, link duration is used to assess link stability as shown at 22. Collected data is used to compute this link metric which labels the edge weight on each wireless link. When a source node requests a connection to a destination node, on demand routing protocols initiate route discovery procedures at 24 which flood route request packets over the network. Link metrics for the traversed links are updated as the route request packets traverse the network. At the destination node, a transmission path is selected at 26 that optimizes a routing metric, where the routing metric is based in part on the link duration of links traversed in each candidate path. Lastly, the destination node sends a route reply message at 28 that specifies the selected transmission path to the source node.

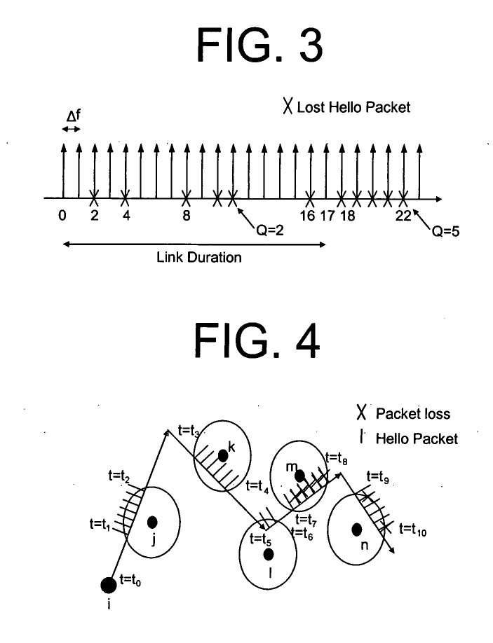

Link duration for a given node may be determined in a variety of ways. In one exemplary approach, periodic connectivity discovery packets (also commonly referred to as hello packets) are broadcasted at a link layer from each node in the network. Each hello packet consists of three fields. The packet type field specifies it is a link level hello packet. The sender ID identifies the sender of the packet. It also contains a list of neighbor node from which the sender has received hello packets. Suppose node i receive hello packets from a neighbor j at a period of Δt=1 second. With reference to FIG. 3, node i starts bookkeeping at time 0 when it receives the first hello packet from j. In an exemplary embodiment, a link is declared down if five consecutive hello packets are missed. In this example, five consecutive hello packet loss is observed at t=22. Link duration is defined as the time until the last hello packet is received prior to link down, i.e. t=17 in this example. Occasionally, channel fluctuations may lead to corrupted hello packets at receive node i, say t=2,4,8,10,11. Although momentary channel fluctuation impacts the packet loss rate of a channel, it does not bring down a link in many protocols. It is envisioned that other indications of a link failure are also within the broader aspects of this disclosure.

To determine link duration of a mobile node, consider a node i starts roaming in a network at t=to as shown in FIG. 4. At t=t₁, node i starts to hear consecutive hello packets from j. If node i is also in the neighbor list of the hello packet from j, it infers that a unidirectional link exists between node i and j. At t=t₂, node i is out of the range of j. Since node i does not receive any more hello packets from j beyond t₂, it infers the link is broken at t₂. The node duration of i with node j is thus given by t₂-t₁, accurate to the granularity of the hello packet inter-arrival time. Suppose node i runs into node k at t=t₃. Although node i is in the range of node k, sometimes hello packets may not be received because of channel fluctuations or interference. If hello packets are not received from k for say five hello intervals, the link is assumed to be down. In our example, loss of hello packets is sporadic for node k. Thus the link is up until t=t₄. The corresponding nodal link duration of node i is t₄-t₃. On the other hand, link i---l and i---m are unstable. Node i passes through node l in the periphery and a link is transient. In the latter case, channel fluctuation or congestion may lead to severe packet loss. In both cases, the absence of five consecutive hello packets received at i shows that the link quality is not good and the link should not be used.

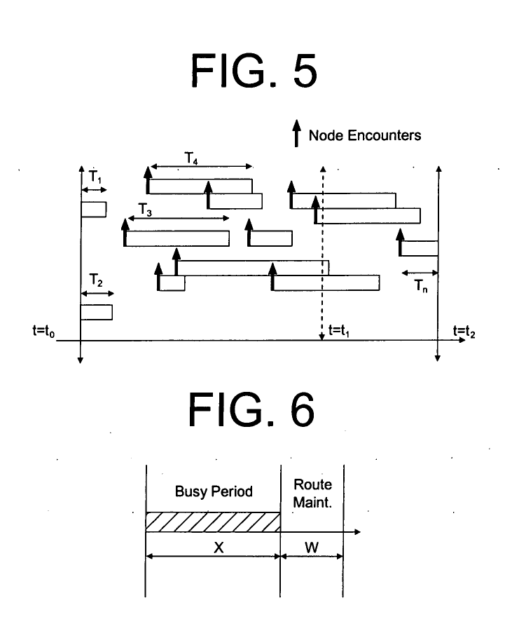

In practice, each node computes a nodal link duration measurement for a sample window of time as shown in FIG. 5. At each time instant, a node is connected to several neighbors. For instance, the node is connected to four neighbors at t=t₁. The link durations to all neighbors during the sample time window interval are monitored. If the sample window is large so that a large number of link durations are sampled, the nodal link duration will converge to an average value provided that speed of node i does not change appreciatively during the sampling window. When the sampling of nodal link duration starts at t=t₀, node i is connected to 2 neighbors. The measured times T₁ and T₂ are actually the excess life or residual life of the links. Similarly, when sampling ends at t=tₑ, node i is connected to one neighbor only. Since node i is still connected to the neighbor when sampling ends, the age of the link is measured. Nevertheless, if the sampling interval is large enough, the number of link duration measurements n is large. The effect of these boundary cases T₁, T₂ and Tₙ on the average nodal link duration can be ignored. In an exemplary embodiment, the nodal link duration rate of node i is defined as the reciprocal of the average nodal link durations, given by

$${λ}_{i} = \frac{1}{\frac{{\sum }_{w = 1}^{n} {T}_{w}}{n}} .$$

Each node computes its nodal link duration rate k periodically but asynchronously. It is subsequently used as the input of routing metrics when a route is solicited during route discovery.

The frequency in which nodal link duration is sampled depends on the mobility of the node. In applications in which node speed change is infrequent and gradual, nodal link duration may be sampled infrequently, say once per hour. If node speed is unsteady and changes swiftly, sampling intervals should be placed more frequently, say every five minutes, to capture the dynamics of speed changes. Note that each node continuously broadcasts hello packets at all time. Since each node asynchronously measures its nodal link duration, periodic hello packets should be broadcasted at all time so that all nodes are aware of all neighbors. In practice, hello packets are small and consume small bandwidth. All hello packets are broadcast and not unicast messages; consumption of bandwidth is O(n) rather than O(n²).

Other techniques for computing link duration are also contemplated by the present disclosure. For example, link duration may be computed from the measured signal strength of transmissions received from other nodes as reported by the link layer of a given node. In this example, link duration may be a summation of time during a sampling window in which the measured signal strength exceeds some threshold for each link. Broader aspects of this disclosure encompass other means for computing the link duration.

Suppose we consider each node as a queuing system. The node acts as a server and a node encounter and the corresponding link duration are treated as an arrival and service time to the queue respectively. A simple application of the Little's law shows that the product of node encounter rate and average link duration should give the average number of nodes connected with the server simultaneously, or the average number of neighbors. Mathematically,

$$\frac{NER}{NLDR} = n ,$$

where n is the average number of neighbors of a node. In practice, measurement of node encounter rate (NER) may yield more accurate results than measurement of nodal link duration rate (NLDR) directly, due to the truncation of link duration measurements in the sampling window. In simulations, it has been verified that the correlation of NER with individual node speed is larger than that of NLDR and individual node speed. Since link encounter rate is proportional to link duration rate, using NER as link metric yields exactly the same routing decisions as the case of NLDR when it is measured precisely without truncation. Accordingly, it is envisioned that node encounter rate may be used in place of link duration as the link metric.

Path stability is obviously one desirable property, especially in networks running TCP on the transport layer. Frequent route changes would throttle TCP throughput and force it to resume transmission from a small contention window. On the other hand, it is sometimes more appropriate to maximize throughput rather than path duration for some applications. To this end, two exemplary routing metrics are further described below. Either routing metric may be employed in the context of the present disclosure. Moreover, it is envisioned that other routing metrics based on link duration are also within the broader scope of this disclosure.

The first metric maximizes the expected path duration for stability. Consider a path with H hops. The nodes along the path is labeled as n₁, n₂, . . . , n_{H+1}. The link duration of each link on the path is denoted as Yᵢ, where Yᵢ denotes the link duration between node nᵢ and nᵢ₊₁. Note that in general H and Yᵢ are random variables. Knowledge on random variables Yᵢ is summarized by the vector of link duration rate [μ₁ μ₂ . . . μ_{H}], where each value of μ is obtained empirically during nodal link duration measurement. For link i between node nᵢ and nᵢ₊₁,

$${μ}_{i} = \frac{{λ}_{{n}_{i}} + {λ}_{{n}_{i + 1}}}{2} .$$

In this disclosure, we restrict our attention to the case where each node has a time invariant random speed. This guarantees that empirical measurement of nodal link durations at each node i converges to constant nodal link duration rate λᵢ.

Since a path is broken if any of the links along the path is broken, we have
X=X(H)=min(Y₁,Y₂, . . . ,Y_{H})
where X denotes the path duration. Using simulations, path duration can be modeled by exponential distribution in high mobility scenarios for a variety of mobility models. It is possible to evaluate the distributions of link duration and path duration. In work from Han et. al., the distributions are computed numerically for the case of random Waypoint mobility model with no pause. It was determined that for large number of hops, path distribution converges to exponential distribution. Although link duration is not exponential in general, this assumption is made to simplify analysis and implementation of routing metric in mobile nodes. Thus, the proposed routing metrics yields significant improvement over min-hop routing in simulations even if link distribution is not exponential. Exponential distributed link duration has also been assumed in some other work.

Suppose the number of hops of a path is given as H=h with corresponding link duration rates [μ₁ μ₂ . . . μ_{H}]. When link duration is assumed exponential, path duration is also exponentially distributed with link duration rate

$${\sum }_{i = 1}^{h} {μ}_{i} = \frac{{λ}_{1}}{2} + {λ}_{2} + … + {λ}_{h} + \frac{{λ}_{h + 1}}{2} .$$

Since the expected path duration is 1/Σμₗ, it is maximized when the above equation is minimized.

Implementation of an exemplary routing protocol using this routing metric may be as follows. When route discovery is invoked, the source node broadcasts route request packets to its neighbors with its metric λ₁/2. An intermediate node nᵢ receives the route request, modifies the current metric λ according to λ=λ+λᵢ and rebroadcasts it to other nodes. When a second duplicate route request is received, node nᵢ will forward the route request again only if the sum metric along the new path is smaller than that in the old path. Upon receiving the first route request packet, the destination node sets aside a time window to receive route request packets from other routes. Upon accumulating a plurality of candidate routes, the destination node selects the path with the least sum metric and unicasts a route reply back to the source node. As noted above, picking the smallest sum maximizes the expected path duration. Other techniques for maximizing the expected path duration based on link duration are also contemplated by this disclosure.

The second metric maximizes path throughput for performance optimization. Long run throughput of reactive protocols is derived as a function of node mobility as shown below. The long run throughput of a flow is determined by drawing results from renewal reward theory. Suppose a source node wants to communicate to a destination node using multihop routing. As time evolves, node mobility shuffles the node locations and routes are set up and tear down alternately. Let M(t), t>0 be a counting process to denote the number of routes established between the source to the destination over time. Each time a route is established, the path last for a random time X (H) as determined by the node mobility of the H+1 nodes. For reactive routing protocol, it is then followed by a random route maintenance time W of arbitrary distribution. The whole time interval between a route is operable and route maintenance finishes the repair of a route is denoted as a cycle. Consider the path duration of the n-th route xₙ. Since network topology is different whenever route discovery is invoked, the path durations Xₙ and the corresponding route maintenance time Wₙ are IID variables. Since M(t) is a counting process with IID interarrival times, M(t) is a renewal process. Moreover, we denote Rₙ as the reward earned in the n-th cycle, or renewal period. If we let

$$R ( t ) = {\sum }_{n , = 1}^{M ( t )} {R}_{n} , \qquad ( 1 )$$

then R(t) is the total reward earned by time t. Let E[R]=E[Rₙ], E[X]=E[Xₙ] and E[W]=E[Wₙ], the renewal reward theorem [23] states that if E[R]<∞ and E[X]+E[W]<∞, then with probability 1,

$${lim}_{t \to ∞} = \frac{R ( t )}{t} = \frac{E [ R ]}{E [ X ] + E [ W ]} \qquad ( 2 )$$

That is, the rate of earning reward in the long run is just the ratio of the expected reward in a cycle and the expected cycle duration. Accordingly, if we define the reward in a cycle as the total amount of data delivered from the source to the destination, then the long run data rate, or throughput Zᵣ of a reactive protocol can be determined.

The long run throughput of the LUNAR protocol can also be determined using renewal reward theory. LUNAR protocol mandatorily invokes route re-discovery at regular time intervals of tᵣ to set up a new route, even if the existing route is fine. Since new routes are established every tᵣ unit time, it also constitutes a renewal, with a renewal period of tᵣ.

Before we go on to derive the long run throughput of reactive protocols Zᵣ and LUNAR protocol Zₚ, we lay down the set of assumptions that we have made. First, we consider only small network scenarios only. Multihop routes are confined to have a hop count of no more than 3 hops. As highlighted in the LUNAR design philosophy, long hop routes are vulnerable to mobility and do not deliver satisfactory throughput performance. The LUNAR protocol thus designates a maximum number of hops of three. Note, however, that our mobility analysis is generic and is applicable to networks that spans more hops with a more detailed model. Second, we consider a network in low offered load regime only. Specifically, we do not consider interactions between two different flows.

Due to transmission concurrency constraint, at each instant only one hop out of a three hop route can seize the channel and transmit. This concurrency constraint is due to the interactions of RTS and CTS packets in CSMA. Suppose the available bandwidth of each link is r. The effective end-to-end throughput of a route is thus r/H to model self interference of multihop transmissions in CSMA/CA protocol. The scaling factor r/H is also relevant for other MAC protocol such as slotted ALOHA. Assuming nodes have large carrier sense range, packet collisions on a multihop route leads to an end-to-end throughput that is roughly given by r/H.

For reactive protocol, the path duration of a route X is the minimum of all the link durations along the route, i.e. X=min(Y₁, Y₂, . . . , Y_{H}). The total amount of data delivered over the lifetime of the route is thus

$${R}_{n} = \frac{rX}{H}$$

With reference to FIG. 6, the duration of the whole cycle is the sum of path duration X and the time for route maintenance, denoted by W. With the use of renewal reward theory, the long run throughput is thus

$${Z}_{r} = \frac{E [ \frac{rX}{H} ]}{E [ W + X ]}$$

The determination of E[rX/H] is as follows.

$$\begin{matrix}E [ \frac{rX}{H} ] = E [ E [ \frac{rX}{H} \vert H ] ] \\ = {\sum }_{h} E [ \frac{rX}{H} \vert H = h ] Pr [ H = h ] \\ = {\sum }_{h} \frac{r}{h} E [ X ( h ) ] Pr [ H = h ]\end{matrix}$$

Assuming link durations along a route are IID exponential random variables, the path duration X is also exponentially distributed with rate Σ^{h}ᵢ₌₁μ_{i.}. Thus,

$$E [ X ( h ) ] = 1 / {\sum }_{i = 1}^{h} {μ}_{i} and \\ E [ \frac{rX}{H} ] = {\sum }_{h} \frac{r}{h {\sum }_{i = 1}^{h} {μ}_{i}} Pr [ H = h ] \qquad ( 3 )$$

Similarly, E[X] can be determined by conditioning on H.

$$\begin{matrix}E [ X ] = E [ E [ X \vert H ] ] \\ = {\sum }_{h} E [ X ( h ) ] Pr [ H = h ] \\ = {\sum }_{h} \frac{Pr [ H = h ]}{{\sum }_{i = 1}^{h} {μ}_{i}}\end{matrix} \qquad ( 4 )$$

Combining the last two equations together we have

$$\begin{matrix}{Z}_{r} = \frac{E [ \frac{rX}{H} ]}{E [ X ] + E [ W ]} \\ = \frac{{\sum }_{h} \frac{r}{h {\sum }_{i = 1}^{h} {μ}_{i}} Pr [ H = h ]}{{\sum }_{h} \frac{Pr [ H = h ]}{{\sum }_{i = 1}^{h} {μ}_{i}}}\end{matrix}$$

For the special case when all nodes have same mobility, all link durations are exponentially distributed with rate μᵢ=μ. The expected path duration E[X (h)] is thus given by hμ. (3) simplifies to

$$E [ \frac{rX}{H} ] = \frac{r}{μ} E [ \frac{1}{{H}^{2}} ]$$

whereas (4) simplifies to
This yields

$$\begin{matrix}E [ X ] = \frac{1}{μ} E [ \frac{1}{H} ] & \\ \begin{matrix}{Z}_{r} = \frac{E [ \frac{rX}{H} ]}{E [ W + X ]} \\ = \frac{rE [ \frac{1}{{H}^{2}} ]}{μ E [ W ] + E [ \frac{1}{H} ]}\end{matrix} & ( 5 )\end{matrix}$$

The above throughput equations is applicable to the case where path duration E[X] is finite, such that renewal theorem holds. For networks in which all nodes are stationary, μᵢ=μ=0∀ᵢ and E[X] diverges. The throughput is determined as follows. Denote the path duration is Xₚ. The throughput in one cycle is given by

$$\begin{matrix}{Z}_{r} = {lim}_{{X}_{p} \to ∞} \frac{{\sum }_{h} \frac{{rX}_{p}}{h} Pr [ H = h ]}{{X}_{p} + E [ W ]} \\ = {lim}_{{X}_{p} \to ∞} \frac{{rX}_{p}}{{X}_{p} + E [ W ]} E [ \frac{1}{H} ] \\ = rE [ \frac{1}{H} ]\end{matrix}$$

Note that in the absence of node mobility, throughput is independent of route maintenance time E[W] and is constrained by self interference imposed by multihop routes only.

Equation (5) gives a generic expression of throughput for reactive routing protocols such as DSR and AODV. Although DSR and AODV differ in implementation details, they also share some salient characteristics of reactive protocols. When these protocols are stripped down of intelligent flooding, route caching and packet salvation, their throughput performance can be roughly modeled by Equation (5).

Our probabilistic analysis confirms that throughput is inversely related to link duration rate. However, the impact of mobility may be minimal if E[W] is small. In the extreme case where route maintenance is efficient, a network flow spends negligible time in the idle state. The long run throughput is completely independent of mobility. In small networks that consist of 15 nodes and 3 hops, flooding overhead in route maintenance is usually low and it may imply mobility does not appreciably degrade network throughput.

On the other hand, throughput is not explicitly dependent on distributions of node locations, traffic pattern, routing logic and routing metrics. Complex interactions of the above factors are intractable and are convenient summarized by the various moments of hop length H. The distribution of H and thus its moments, however, can be collected easily in simulations or in a testbed experiment.

In this subsection, we derive the long run throughput of the LUNAR protocol. In written protocol, a renewal occurs every time route rediscovery is invoked. The cycle duration is thus equal to the route rediscovery interval tᵣ.

$$\begin{matrix}{X}^{′} = min ( {Y}_{1} , {Y}_{2} , … , {Y}_{H} , {t}_{r} ) = min ( X , {t}_{r} ) \\ E [ \frac{{rX}^{′}}{H} ] \\ = E [ E [ \frac{{rX}^{′}}{H} \vert H ] ] \\ = {\sum }_{h} \frac{r}{h} {X}^{′} ( h ) Pr [ H = h ] \\ = {\sum }_{h} \frac{rPr [ H = h ]}{h} ( {\int }_{0}^{{t}_{r}} xf ( x \vert h ) ⅆ x + {\int }_{{t}_{r}}^{∞} {t}_{r} f ( x \vert h ) ⅆ x )\end{matrix} \qquad ( 6 )$$

where

$$f ( x \vert h ) = ( {\sum }_{i = 1}^{h} {μ}_{i} ) {ⅇ}^{x {\sum }_{i = 1}^{h} {μ}_{i}}$$

Evaluating (6) yields

$$\begin{matrix}{Z}_{p} = \frac{E [ \frac{{rX}^{′}}{H} ]}{{t}_{r}} \\ = {\sum }_{h} \frac{rPr [ H = h ]}{{ht}_{r}} \frac{1 - {ⅇ}^{- {t}_{r} {\sum }_{i = 1}^{h} {μ}_{i}}}{{\sum }_{i = 1}^{h} {μ}_{i}}\end{matrix}$$

For the special case where all nodes have same speed, μᵢ=μ for all i. This equation becomes

$$\begin{matrix}{Z}_{p} = \frac{E [ \frac{{rX}^{′}}{H} ]}{{t}_{r}} \\ = \frac{r}{μ {t}_{r}} {\sum }_{h} \frac{1}{{h}^{2}} ( 1 - {ⅇ}^{- h μ {t}_{r}} ) Pr [ H = h ]\end{matrix}$$

Using Taylor's series expansion,

$$1 - {ⅇ}^{- h μ {t}_{r}} = {\sum }_{i = 1}^{∞} \frac{{( h μ {t}_{r} )}^{i}}{i !} {( - 1 )}^{i + 1}$$

At low mobility, μtᵣ<<1, a first order approximation yields

$${Z}_{p} = rE [ \frac{1}{H} ]$$

We observe that Zₚ is only dependent on the distribution of hop length. At low node mobility, the path duration is longer than route re-discovery time tᵣ with high probability. Throughput is only constrainted only by spatial concurrency in multihop transmissions in the factor E[1/H]. Furthermore, when μᵢ=μ=0 for all i, Zₚ, =Zᵣ. It is obvious in the absence of node mobility, a flow is busy all the time and throughput is constrained only by self interference imposed by multihop transmissions.

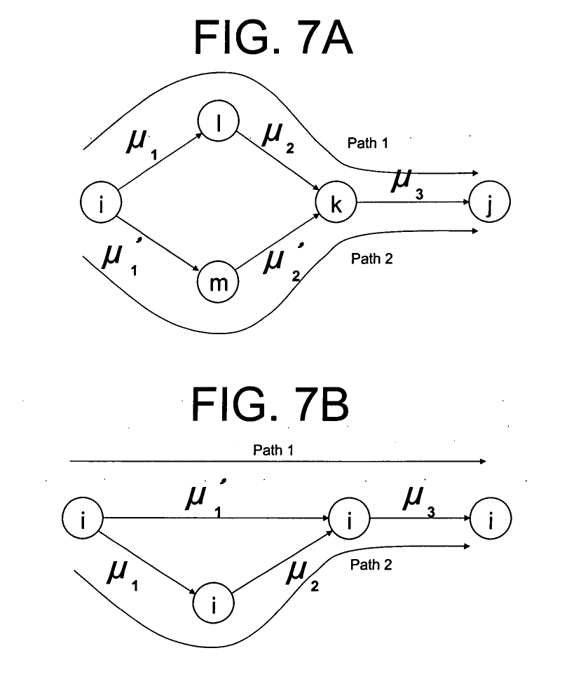

An exemplary routing protocol using a throughput routing metric may be implemented as follows. With reference to FIG. 7A, a destination node j can evaluate the expected throughput between all possible paths emanated from source node i. This involves every node to forward every route request packets that it receives, provided that the path taken by the packet contains no loops. Intermediate node k receives route request packets from two paths emanated from node i. Since both paths to intermediate node k do not contain any loops, node k will forward both route request packets. A route request packet will not be forwarded after it reaches the destination node, or a maximum of three hops is reached. Upon reception of the first route request packet, node j waits for an open time to learn more candidate routes. A route reply packet is then unicasted over the path that yields the largest throughput. Other techniques for maximizing path throughput based on link duration are also contemplated by this disclosure.

The above scheme may be impractical in a dense network. In the worst case, all N network nodes are in transmit range with each other. If the maximum number of hops is h, the number of route request messages would be O(N^{h}). It is possible to reduce the number of superfluous control packets. If intermediate node k decides that path 2 does not yield a larger throughput than path 1, the route request packet is not forwarded. Define the throughput from node i to intermediate node k as the intermediate throughput. Since throughput is not an additive function of link metrics, it may happen that path 2 has a higher intermediate throughput but the end-to-end throughput is smaller. However, for an ad hoc horizon of three hops, an intermediate node always has sufficient information to determine whether to forward a route request packet or not.

For an ad hoc horizon of three hops, two cases are considered. With continued reference to FIG. 7A, intermediate node k receives route request packets from two paths. In this example, the number of hops from node i to k on both paths are two hops. With a slight abuse of notation, we define

$$Z ( {\sum }_{i = 1}^{h} {μ}_{i} )$$

as the throughput of a path of h hops with link metric [μ₁ μ₂ . . . μₕ]. It can be shown that if the throughput to intermediate node k on path 2 is higher, then path 2 also has a higher throughput to the destination j due to the monotonicity of f(.). Mathematically,
Z(μ₁+μ₂)<Z(μ′₁+μ′₂) [symbol] Z(λ₁+μ₂+μ₃)<Z(μ′₁+μ′₂+μ₃)
In this case, node k can determine the relative end-to-end throughput of both paths based on the intermediate throughput terminated at node k. It will forward the route request packet of path 2 if
Z(μ₁+μ₂)<Z(μ′₁+μ′₂)
Moreover, this forwarding rule is equivalent to
μ₁+μ₂<μ′₁+μ′₂.
When both intermediate paths have the same number of hops, throughput maximization is equivalent to path duration maximization.

Referring to FIG. 7B, intermediate node k receives route request packets from i via path 1 and 2. Intermediate path 1 and 2 are respectively one and two hops. Suppose the nodal link duration rate of node i is λᵢ. Accordingly, we have

$${μ}_{1}^{′} = \frac{{λ}_{i} + {λ}_{j}}{2}$$

$${μ}_{1} = \frac{{λ}_{i} + {λ}_{l}}{2}$$

$${μ}_{2} = \frac{{λ}_{l} + {λ}_{k}}{2}$$

Since μ₁+μ₂>μ₁, intermediate throughput of path 1 is always larger due to monotonicity of f(.). Moreover, Z(μ₁+μ₂)<Z(μ′₁) [symbol] Z(μ₁+μ₂+μ₃)<Z(μ′₁+μ₃). Thus intermediate node k can drop the route request packet from path 2 even if it has no information on the value of μ₃.

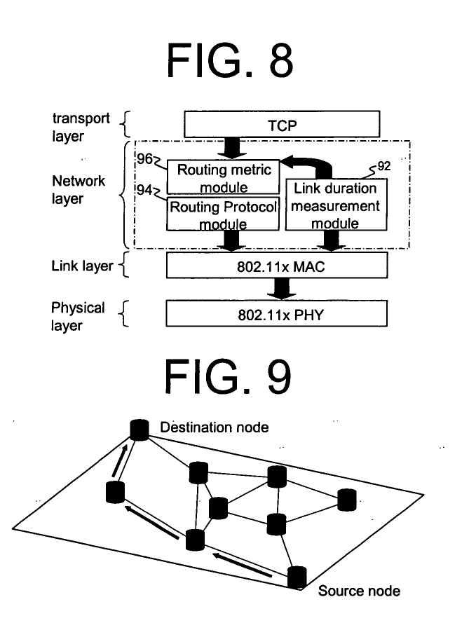

FIG. 8 illustrates how the link duration based routing protocols might be integrated into the software architecture of a node in the network. The number of modifications to the protocol stack should be minimized. In particular, modification of the link layer (e.g., 802.11 MAC protocol) should be avoided to encourage adoption of this approach. Accordingly, functionality of the link duration based routing protocol is preferably implemented in the network layer. However, it is envisioned that this functionality may be implemented at other layers of the protocol stack.

In this exemplary embodiment, a link duration measurement module 92 is operable to broadcast single hop hello packets to determine link layer connectivity between nodes. The link duration measurement module 92 is also adapted to receive hello packets from other network nodes and determine the link duration measure for the node in a manner described above. A routing protocol module 94 generates route request packets as part of the route discovery procedure; whereas, a routing metric module 96 is adapted to receive route request packets and operable to compute a routing metric based on the link duration in the manner described above.

FIG. 9 depicts an application scenario in which link duration based routing protocol is deployed. For instance, in a camera surveillance network, a couple of nodes equipped with cameras are sprinkled into an area. Some nodes may be mobile while others may be stationary over the duration of the communication session. Through measurement of link duration, the two classes of nodes can be differentiated. When the link metrics are taken into account during route discovery, it leads to the selection of routes that traverse only through the low speed nodes if possible. In another application scenario, mobile robots equipped with cameras filtrate a disaster scene inaccessible to rescue personnel.

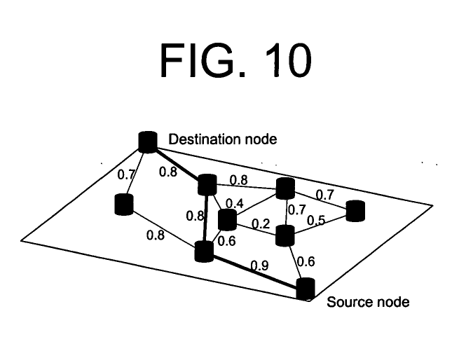

FIG. 10 depicts another potential application scenario for the link duration based routing protocol. In this example, all nodes are stationary. The routing protocol fits into the application of a community mesh network, in which users in a neighborhood form a mesh to share a centralized broadband connection. In contrast to the ETX and ETT routing metric, which optimizes for the transmission of one packet, the routing protocols of this disclosure optimize for the expected throughput and path duration of a communication session. In this case, average link duration of a link is a simple function of the forward and reverse packet loss rate on the link, where the edge weights represent the link loss rate.

While a few application scenarios have been described above, it is readily understood that the routing protocols of the present disclosure are applicable to other network environments. Thus, the above description is merely exemplary in nature and is not intended to limit the present disclosure, application, or uses. It should be understood that throughout the drawings, corresponding reference numerals indicate like or corresponding parts and features.

What is claimed is:

1. A method for selecting a route for transmitting data packets amongst nodes in an ad hoc network, comprising:
initiating a route discovery procedure that generates a plurality of candidate transmission paths between a source node and a destination node;
determining a metric which is indicative of link stability between nodes in the network; and
selecting a transmission path from amongst the plurality of candidate paths using the metric for nodes associated with each candidate path.

2. The method of claim 1 wherein determining a metric further comprises determining a duration for links between the nodes in the network.

3. The method of claim 2 wherein determining link duration further comprises detecting link existence through the use of connectivity discovery packets and estimating link duration from the connectivity discovery packets.

4. The method of claim 2 wherein determining link duration further comprises measuring signal strength of transmissions from other nodes at each of the nodes of the network.

5. The method of claim 2 wherein the route discovery procedure further comprises sending a route request packet from a source node; and updating link duration information encapsulated in the route request packet at each node along the path traversed by the route request packet in the network.

6. The method of claim 5 wherein selecting a transmission path further comprises comparing a path metric that is derived from link duration information accumulated along each of the plurality of candidate paths and selecting the transmission path based on the comparison.

7. The method of claim 1 further comprises selecting a transmission path having a maximum path duration from amongst the plurality of candidate paths.

8. The method of claim 1 further comprises selecting a transmission path having maximum throughput from amongst the plurality of candidate paths.

9. A method for selecting a route for transmitting data packets in a mobile ad-hoc network, comprising:
determining link duration between nodes in the network prior to route discovery, where link duration is an amount of time a given node maintains a link with neighboring nodes;
initiating a route discovery procedure which results in a plurality of candidate transmission paths between a source node and a destination node; and
selecting a transmission path from amongst the plurality of candidate paths based in part on the link duration of nodes associated with each candidate path.

10. The method of claim 9 wherein determining a link duration further comprises determining and maintaining link duration at each node in the network.

11. The method of claim 9 wherein determining link duration further comprises receiving periodic HELLO packets from neighboring nodes and computing link duration based on the HELLO packets.

12. The method of claim 9 wherein determining link duration further comprises observing signal strength from neighboring nodes and computing link duration based on the observed signal strength.

13. The method of claim 9 wherein the route discovery procedure further comprises sending a route request packet from a source node; and updating link duration information encapsulated in the route request packet at each node along the path traversed by the route request packet in the network.

14. The method of claim 13 wherein the link duration information is defined as expected path duration, 1/Σμₗ, where
$${\sum }_{i = 1}^{h} {μ}_{i} = \frac{{λ}_{1}}{2} + {λ}_{2} + … + {λ}_{h} + \frac{{λ}_{h + 1}}{2}$$
and λₕ is a reciprocal of the link duration for a given node, h, along the path.

15. The method of claim 14 further comprises selecting the transmission path having the longest expected path duration.

16. The method of claim 13 further comprises determining a throughput measure for each candidate path based on the link duration information for the candidate path and select the transmission path having the greatest expect throughput.

17. A node in a mobile ad-hoc network, comprising:
a link duration module residing in a network layer and operable determine link duration for the node, where link duration is an amount of time the node maintains a link with neighboring nodes; and
a routing metric module adapted to receive route request packets and operable to compute a routing metric based on the link duration.

18. The node of claim 17 wherein the link duration module is adapted to receive connectivity discovery packets from other nodes in the network and computing link duration based on the connectivity discovery packets.

19. The node of claim 17 wherein the link duration module is operable to broadcast connectivity discovery packets to other nodes in the network.

20. The node of claim 17 wherein the routing metric module resides in a network layer of the node and is operable to update the route request packets with the link duration for the node.

21. The node of claim 17 further comprises a route protocol module residing in a network layer and operable to generate route request packets.
